(19) United States
(12) Patent Application Publication
(10) Pub. No.: US 2024/0159542 A1
(43) Pub. Date: May 16, 2024

(54) INFORMATION PROCESSING METHOD AND APPARATUS FOR ISSUING WARNING, MARINE VESSEL, AND STORAGE MEDIUM

(71) Applicant: YAMAHA HATSUDOKI KABUSHIKI KAISHA, Iwata-shi (JP)

(72) Inventors: Hirofumi AMMA, Shizuoka (JP); Hidenori SATAKE, Shizuoka (JP); Yukitaka OKAMOTO, Shizuoka (JP); Hideyoshi SATO, Shizuoka (JP)

(21) Appl. No.: 18/506,277

(22) Filed: Nov. 10, 2023

(30) Foreign Application Priority Data
Nov. 16, 2022 (JP) 2022-183425

(51) Int. Cl. G01C 21/20

(52) U.S. Cl. CPC G01C 21/203

(57) ABSTRACT

An information processing apparatus and method to prevent a situation in which a warning cannot be issued when a marine vessel enters an out-of-service communication area includes a controller configured or programmed to acquire a position of the marine vessel, at least one of a speed or a traveling direction of the marine vessel, and communication area information. The controller is configured or programmed to determine whether the marine vessel has been close to the out-of-service communication area based on the position of the marine vessel and at least one of the speed or the traveling direction of the marine vessel, and download location information including call attention information used to issue a warning corresponding to the position of the marine vessel when the marine vessel is close to the out-of-service communication area.

### CROSS REFERENCE TO RELATED APPLICATIONS

This application claims the benefit of Japanese Patent Application No. 2022-183425, filed Nov. 16, 2022, which is hereby incorporated by reference wherein in its entirety.

### BACKGROUND OF THE INVENTION

### 1. Field of the Invention

The present invention relates to an information processing method and an apparatus for issuing a warning, a marine vessel, and a non-transitory storage medium.

### 2. Description of the Related Art

In the field of vehicles, in order to continuously use a communication service as much as possible even if a vehicle moves out of a range of a communication network, a technique is disclosed in which, in a case where there is information to be acquired before the vehicle enters the out-of-range region of the communication network, download of the information is requested (Japanese Laid-open Patent Publication (Kokai) No. 2017-62689).

On the other hand, in the field of marine vessels, there is an operation of issuing a warning when a marine vessel enters a region where entry prohibition, slowdown, or the like is set. A marine vessel or a vessel operator needs to acquire location information including call attention information for issuing a warning at any time during navigation.

However, when the marine vessel enters the out-of-service communication area, the location information cannot be newly acquired, and thus a warning may not be issued.

### SUMMARY OF THE INVENTION

Preferred embodiments of the present invention provide information processing methods and apparatuses, marine vessels, and non-transitory storage mediums that are each able to prevent a situation in which a warning cannot be issued when the marine vessel enters an out-of-service communication area.

According to a preferred embodiment of the present invention, an information processing method executed by a computer of a communication apparatus able to communicate with a server includes acquiring a position of a marine vessel, and at least one of a speed of the marine vessel or a traveling direction of the marine vessel; acquiring communication area information indicating whether a region on a chart is a service communication area or an out-of-service communication area; determining whether or not the marine vessel has been close to the out-of-service communication area based on the position of the marine vessel and the at least one of the speed of the marine vessel or the traveling direction of the marine vessel; and downloading, from the server, location information including call attention information used to issue a warning regarding a region corresponding to the position of the marine vessel in response to the determination that the marine vessel has been close to the out-of-service communication area.

According to this configuration, a computer of a communication apparatus able to communicate with a server acquires a position of a marine vessel and at least one of a speed of the marine vessel or a traveling direction of the marine vessel, acquires communication area information indicating whether a region on a chart is a service communication area or an out-of-service communication area, determines whether or not the marine vessel has been close to the out-of-service communication area based on the position of the marine vessel and the at least one of the speed of the marine vessel or the traveling direction of the marine vessel, and downloads, from the server, location information including call attention information used to issue a warning regarding a region corresponding to the position of the marine vessel in response to the determination that the marine vessel has been close to the out-of-service communication area. Therefore, it is possible to prevent a situation in which a warning cannot be issued when the marine vessel enters the out-of-service communication area.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a diagram illustrating a configuration of an information processing system.

FIG. 2 is a side view of a marine vessel.

FIG. 3 is a block diagram of a main portion of the information processing system.

FIG. 4 is a conceptual diagram of map information.

FIG. 5 is a conceptual diagram of a detailed map.

FIG. 6 is a diagram illustrating a functional block that implements a location information acquisition process in a mobile terminal.

FIG. 7 is a flowchart illustrating a location information acquisition process.

FIGS. 8A to 8C are conceptual diagrams illustrating a positional relationship between a marine vessel and a mobile terminal.

FIG. 9 is a flowchart illustrating a position information providing process.

FIG. 10 is a diagram illustrating a functional block that implements a position information providing process in a mobile terminal.

FIG. 11 is a conceptual diagram illustrating a positional relationship between a marine vessel and a mobile terminal.

FIGS. 12A and 12B are each a portion of a flowchart illustrating a position information providing process according to a first modification or a second modification of a preferred embodiment of the present invention.

### DETAILED DESCRIPTION OF THE PREFERRED EMBODIMENTS

Hereinafter, preferred embodiments of the present invention will be described with reference to the drawings.

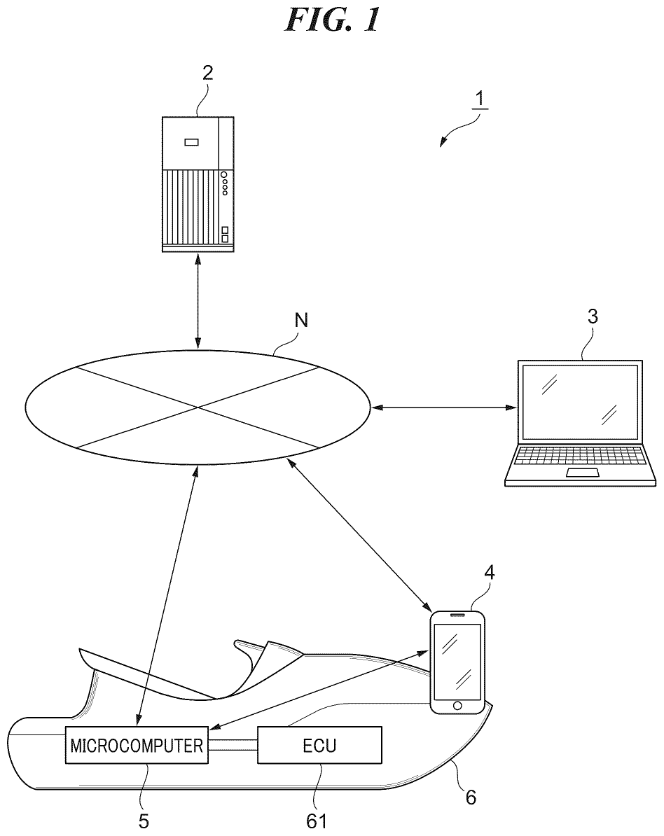

FIG. 1 is a diagram illustrating a configuration of an information processing system 1 according to a first preferred embodiment of the present invention.

The information processing system 1 includes a server 2, a PC terminal 3, a mobile terminal 4, a microcomputer 5, and an engine control unit (ECU) 61. The ECU 61 is mounted on a marine vessel 6. The server 2, the PC terminal 3, the mobile terminal 4, and the microcomputer 5 are connected to communicate with one another wirelessly or by wire via a network N. The mobile terminal 4 and the microcomputer 5 are directly connected and communicable with each other in a wired or wireless manner. Note that the numbers of each component included in the information processing system 1 may be two or more.

The PC terminal 3 may be a personal computer (PC), for example. The PC terminal 3 may be a smartphone, a tablet, a mobile phone, a notebook PC, or a wearable computer, for example.

The mobile terminal 4 is a mobile terminal (communication apparatus) attached to the marine vessel 6. The mobile terminal 4 may be held by a person on board the marine vessel 6. The mobile terminal 4 is typically a smartphone, or may be an information processing apparatus such as a PC, a tablet, a mobile phone, a notebook PC, or a wearable computer.

The microcomputer 5 is an information processing apparatus including a semiconductor device mounted on a substrate in the marine vessel 6 or a combination of a semiconductor device and an electronic component. The microcomputer 5 is implemented by hardware, firmware or software, or a combination thereof.

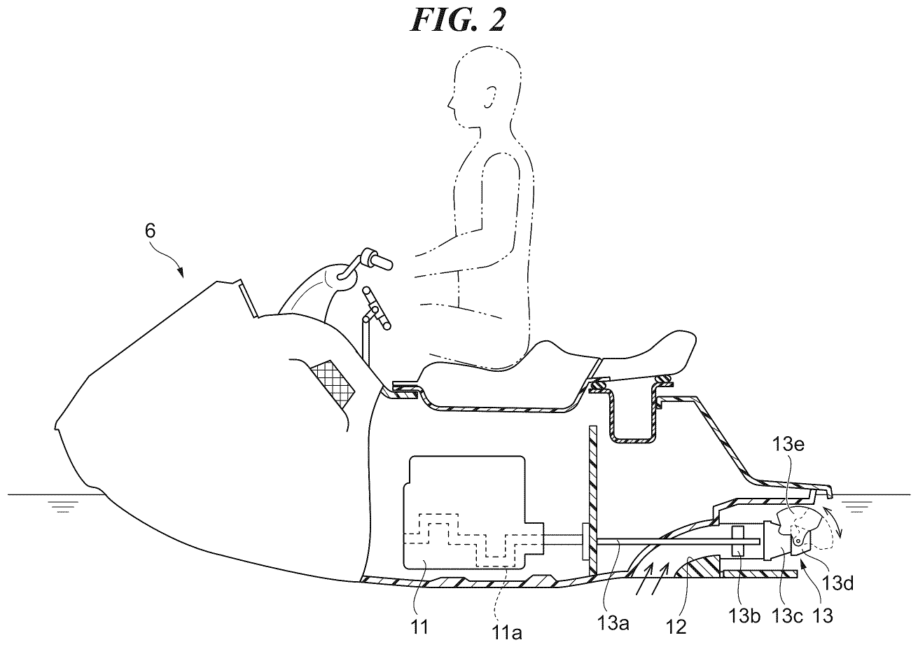

FIG. 2 is a side view of the marine vessel 6. The marine vessel 6 may be, for example, a water jet propulsion boat (watercraft), and is a so-called personal watercraft (PWC). Note that the type of the marine vessel 6 is not limited to a personal watercraft. Therefore, the marine vessel 6 may be a jet propulsion boat (sports boat or the like) other than a personal watercraft. In addition, the marine vessel 6 is not limited to a personal watercraft, and may be a marine vessel propelled by an outboard motor, an inboard motor, or an inboard/outboard motor.

The marine vessel 6 includes an engine 11 and a jet-propelled propulsion unit 13 to generate thrust by a driving force of the engine 11. The engine 11 and the propulsion unit 13 are propulsion devices to propel the marine vessel 6.

The engine 11 includes a crank shaft 11a. The propulsion unit 13 is driven by the engine 11 to take water into the water passage 12 including an opening provided on the lower surface of the rear portion of the marine vessel 6 and eject the water from the nozzle 13c located at the rear end of the marine vessel 6. As a result, the marine vessel 6 is propelled.

The propulsion unit 13 includes a drive shaft 13a, an impeller 13b, a nozzle 13c, a deflector 13d, and a reverse gate (bucket) 13e. The drive shaft 13a extends in the front-rear direction, and includes a front end connected to the crank shaft 11a and a rear end disposed in the water passage 12. The impeller 13b is fixed near the rear end of the drive shaft 13a.

The impeller 13b rotates together with the drive shaft 13a to generate a flow toward the nozzle 13c in the water passage 12. The nozzle 13c is disposed at a most downstream position of the water passage 12 in which the impeller 13b is disposed. The nozzle 13c functions as a water discharge port (ejection port). That is, the nozzle 13c is configured to eject water to generate propulsive force. The deflector 13d and the reverse gate 13e are provided in the nozzle 13c.

The deflector 13d is rotatable in the left-right direction about an axis extending in the up-down direction, and is configured to change the direction of water jetted from the nozzle 13c in the left-right direction. The reverse gate 13e is rotatable in the vertical direction about an axis extending in the horizontal direction. That is, the reverse gate 13e is configured to be able to change the direction of the water jetted from the nozzle 13c in the front-rear direction.

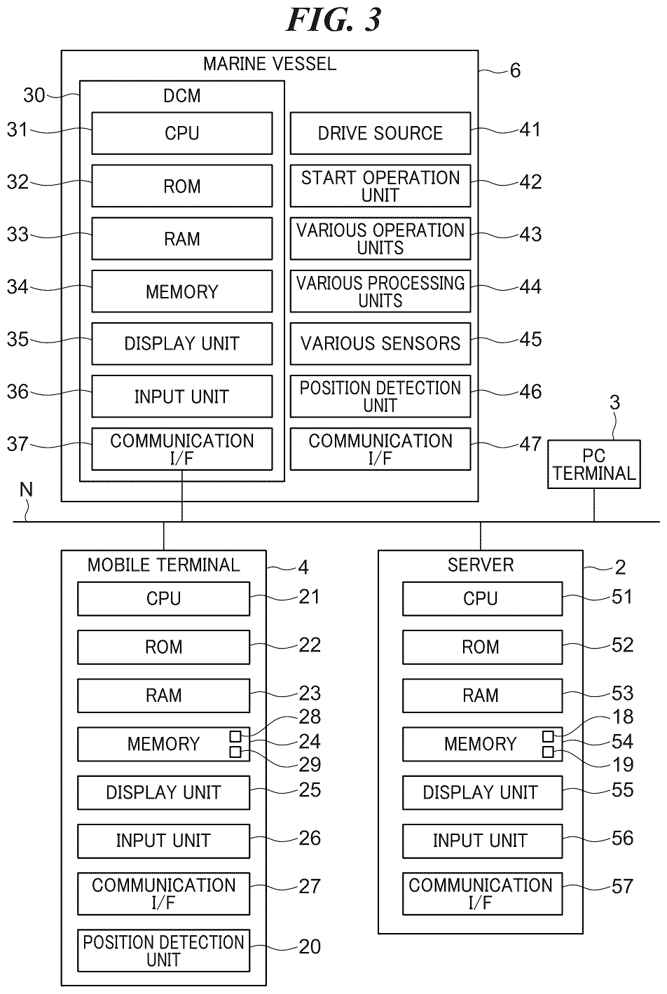

FIG. 3 is a block diagram of a main portion of the information processing system 1. The marine vessel 6 includes a CPU 31, a ROM 32, a RAM 33, a memory 34, a display unit 35, an input unit 36, a communication interface (I/F) 37, and a timer (not illustrated), which can be included in a data communication module (DCM) 30. The ROM 32 or the memory 34 stores a control program. The microcomputer 5 (FIG. 1) includes the CPU 31, the ROM 32, the RAM 33, the memory 34, and the like.

The CPU 31 implements various control processes by developing a control program stored in the ROM 32 or the like in the RAM 33 and executing the control program. The RAM 33 provides a work area when the CPU 31 executes the control program. The display unit 35 displays various types of information. The input unit 36 receives an input of a set value and an input of a mode from a vessel operator of the marine vessel 6. The communication I/F 37 is able to communicate with the network N, and is also able to communicate with the ECU 61 (FIG. 1) that controls the drive source 41 (corresponding to the engine 11) by a controller area network (CAN) or the like.

The marine vessel 6 includes the drive source 41, a start operation unit 42, various operation units 43, various processing units 44, various sensors 45, a position detection unit 46, a communication I/F 47, and a shift mechanism 48.

The start operation unit 42 is a start switch or the like to input an instruction to start the drive source 41. The various operation units 43 are operation units operated by a vessel operator to steer the marine vessel, such as a steering wheel and a remote controller. The various operation units 43 are also used by the vessel operator to input various settings. The various processing units 44 include the ECU 61 and process various operations related to the marine vessel 6. The various sensors 45 include sensors to detect operations of the various operation units 43.

The various sensors 45 may include an acceleration sensor, a velocity sensor, an angular velocity sensor, an azimuth sensor, an engine rpm sensor, a shift position sensor, and the like (none of which are illustrated). The position detection unit 46 receives a GPS signal (positioning information) from a global positioning system (GPS) satellite, and outputs position information indicating the current position of the marine vessel 6. The communication I/F 47 is able to communicate with the communication I/F 37 via CAN or the like.

The velocity sensor among the various sensors 45 detects the navigation speed (vessel speed) of the marine vessel 6. The azimuth sensor detects the azimuth of the marine vessel 6. Note that a method of detecting the speed and the azimuth of the marine vessel 6 is not limited, and for example, the speed and the azimuth may be detected (determined or calculated) based on the position information acquired by the position detection unit 46. The speed of the marine vessel 6 may be determined based on at least one of the engine rpm NE detected by the engine rpm sensor or the position information acquired by the position detection unit 46. For example, the CPU 31 may determine, as the speed of the marine vessel 6, an intermediate value between the speed estimated from the engine rpm NE and the speed estimated from the transition of the position information.

The CPU 21 of the mobile terminal 4 may receive the engine rpm NE and the position information from the microcomputer 5 and may determine the speed of the marine vessel 6 based on at least one of the engine rpm NE or the position information.

The shift mechanism 48 includes the reverse gate 13e and a lever (not illustrated) to operate the reverse gate 13e. The shift position sensor among the various sensors 45 detects a shift position of the shift mechanism 48. When the marine vessel 6 is a PWC, the shift position sensor detects the position of the reverse gate 13e. The reverse gate 13e can be positioned at a forward position, a neutral position, and a backward position.

Note that in a shift mechanism configured to change a shift position via a gear, such as a shift mechanism applied to an outboard motor or the like, the shift position sensor can detect a shift position of a forward-backward switching mechanism in a propulsion device that propels a marine vessel. Note that, depending on the configuration, the shift position sensor may detect an actual shift position of the shift mechanism, or may detect an instruction position indicating the shift position.

The detection results by the various sensors 45, the position detection unit 46, and the like and the mode information are transmitted to the mobile terminal 4 as needed. Furthermore, the CPU 31 determines whether the reception state of the GPS signal by the position detection unit 46 is good or bad, and transmits the information about the determination to the mobile terminal 4 as needed.

The mobile terminal 4 includes a CPU 21, a ROM 22, a RAM 23, a memory 24, a display unit 25, an input unit 26, a communication I/F 27, a position detection unit 20, and a timer (not illustrated). The CPU 21 implements various control processes by developing a control program stored in the ROM 22 or the memory 24 in the RAM 23 and executing the control program. The RAM 23 provides a work area when the CPU 21 executes the control program. The display unit 25 displays various types of information. The input unit 26 receives inputs of various settings and inputs of various instructions from the user of the mobile terminal 4.

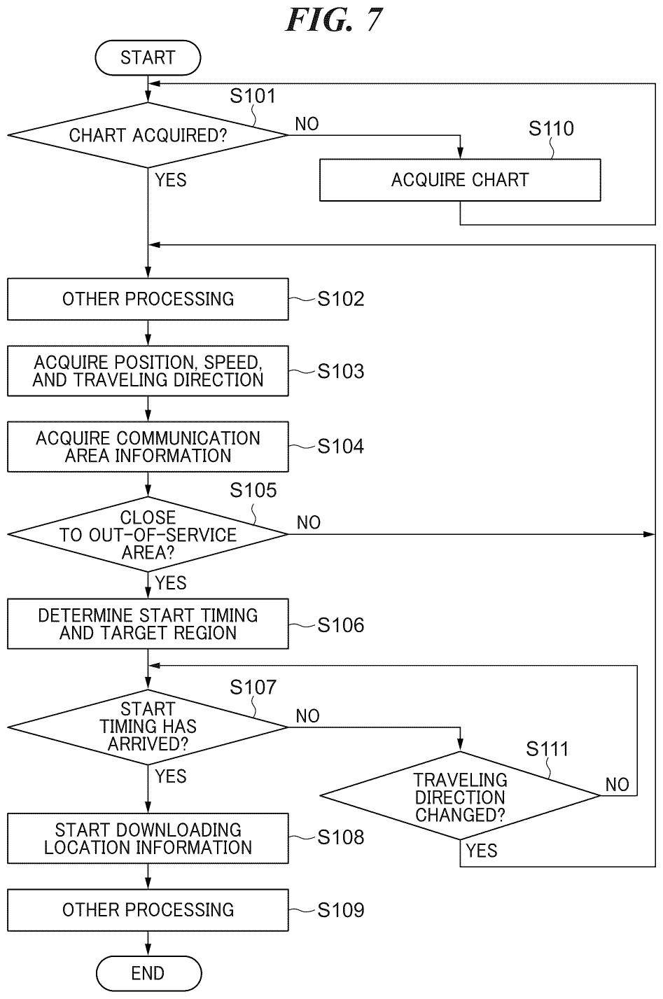

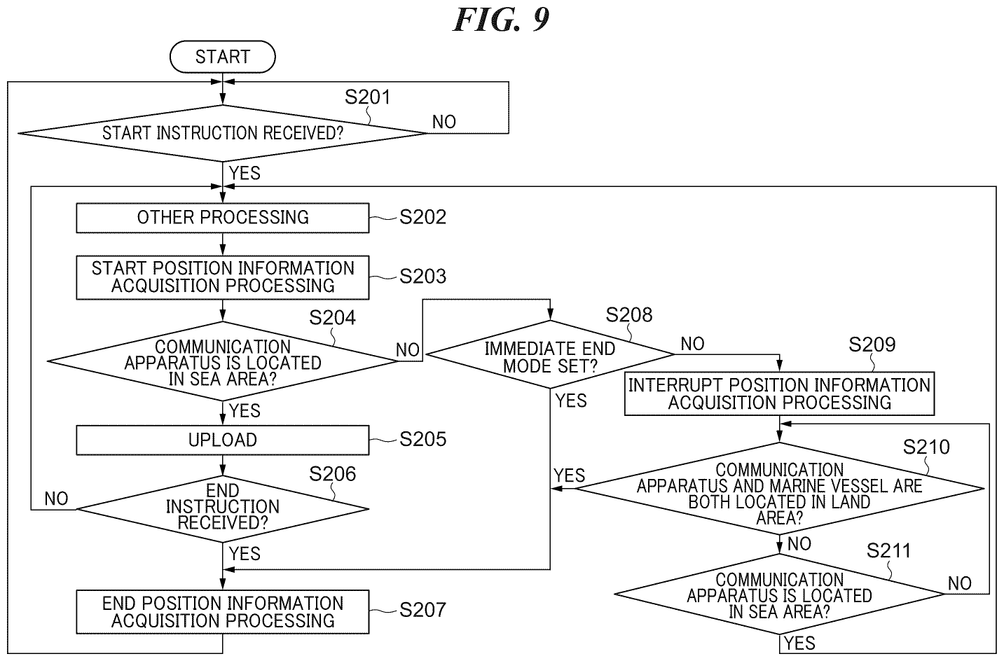

The memory 24 stores applications to implement various processes. For example, a location information acquisition process (FIG. 7) to be described below is implemented by the application 28 downloaded from the server 2. Furthermore, a position information providing process (FIG. 9) to be described below is implemented by the application 29 downloaded from the server 2. In the present preferred embodiment, the application 29 is not essential. The communication I/F 27 is able to communicate with the network N. The communication I/F 27 also includes a near field wireless communication function such as Bluetooth (registered trademark). The position detection unit 20 receives a GPS signal from a GPS satellite and outputs position information indicating the current position of the mobile terminal 4.

The server 2 includes a CPU 51, a ROM 52, a RAM 53, a memory 54, a display unit 55, an input unit 56, a communication I/F 57, and a timer (not illustrated). The configurations of the CPU 51, the ROM 52, the RAM 53, the memory 54, and the display unit 55 are basically similar to those of the CPU 21, the ROM 22, the RAM 23, the memory 24, and the display unit 25 of the mobile terminal 4, respectively. The input unit 56 receives inputs of various settings and inputs of various instructions from the user of the server 2. The memory 54 stores applications that implement various processes. The memory 54 also stores map information 18 and location information 19 to be described below. The communication I/F 57 is able to communicate with the network N.

The numbers of each of the marine vessel 6, the mobile terminal 4, and the PC terminal 3, which are communicably connected to the server 2 may be two or more. Note that the communication I/Fs 57, 27, 37, and 47 may include a plurality of communication functions, and a method of the communication functions may be wired or wireless. In addition, any of the communication I/Fs 57, 27, 37, and 47 may include a function of communicating with the network N, and/or may include a near field wireless communication function.

The map information 18 and the location information 19 will be described. The map information 18 is information on a relatively rough chart (including information on coasts and islands) covering a wide area. The marine vessel 6 communicably connected to the server 2 can acquire the map information 18 from the server 2 at any time. The map information 18 includes communication area information indicating whether a region on the chart is a service communication area or an out-of-service communication area. Hereinafter, the “service communication area” is simply referred to as “service area”, and the “out-of-service communication area” is simply referred to as “out-of-service area”. The map information 18 also includes call attention information for each roughly divided area. The call attention information is information used when a warning is issued, and is, for example, information used to notify “the area is a speed limit area in which the navigation speed is limited”, “the area is an audio limit area in which audio volume is limited”, “the area is an entry prohibited area in which entry of a marine vessel is prohibited”, and the like. Any method may be used to issue the warning as long as the warning is able to be notified to the vessel operator or the like of the marine vessel 6 and, for example, may be a warning by display on the display unit of the marine vessel 6, or a warning by light and/or sound using equipment installed on the marine vessel 6.

The location information 19 is information corresponding to a “target region” determined according to the navigation state of the marine vessel 6 among the entire region covered by the map information 18. The location information 19 includes a plurality of pieces of information, and specifically includes call attention information, a detailed map 18a (detailed map information), and structure information. The marine vessel 6 downloads the location information 19 corresponding to an appropriate target region from the server 2 at an appropriate timing by a process to be described below.

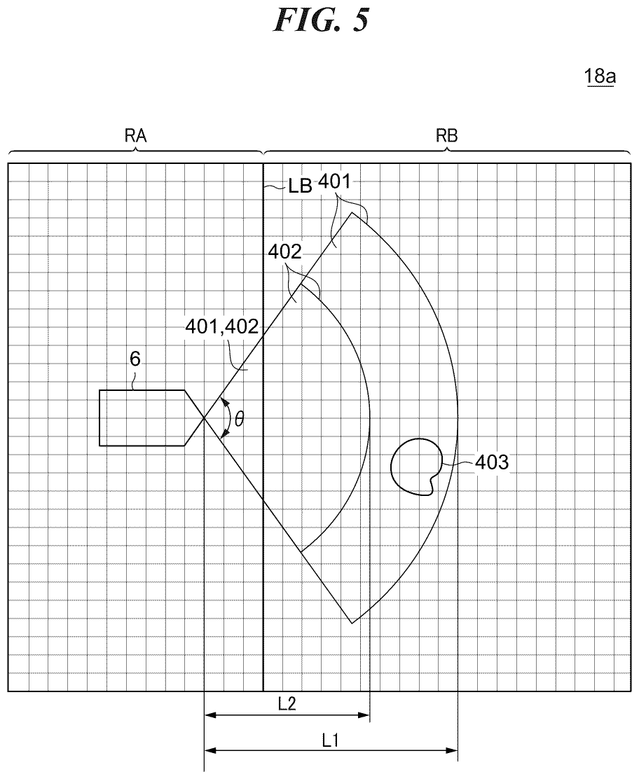

The server 2 manages regions on the detailed map 18a in units of tiles which are regions acquired by dividing a region on the detailed map 18a into a mesh shape, that is, a lattice shape (FIG. 5 to be described below). The tile is a section finer than the section in the map information 18, and is specified by, for example, a tile coordinate. The tile coordinate is defined by coordinate in two directions orthogonal to each other. In the location information 19, the presence or absence of the call attention information and the presence or absence of the structure information is associated with each tile in the target region.

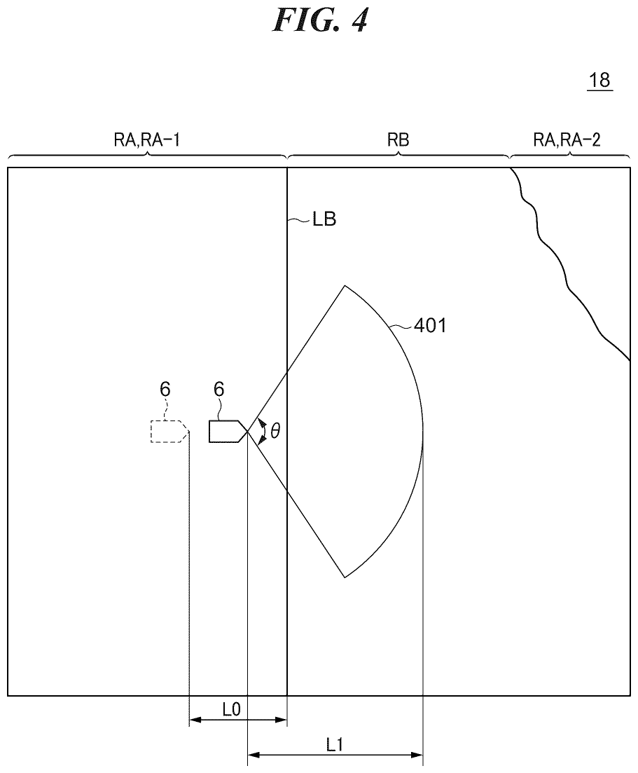

FIG. 4 is a conceptual diagram of the map information 18. FIG. 5 is a conceptual diagram of the detailed map 18a. The detailed map 18a of FIG. 5 illustrates some of all areas of the map information 18. The map information 18 (FIG. 4) and the detailed map 18a (FIG. 5) are displayed on the display unit 55 of the server 2, and are displayed on the display unit 25 of the mobile terminal 4 held by the vessel operator of the marine vessel 6, which is executing the location information acquisition process (described below with reference to FIG. 7). The detailed map 18a is information of a region including at least the target region 401 (described below). Note that the map information 18 and the detailed map 18a may be displayed on only one of the display unit 55 and the display unit 25, and is not necessary to be displayed on both of them.

As illustrated in FIG. 4, the map information 18 includes information indicating the service area RA (RA-1, RA-2) and the out-of-service area RB. A boundary between the service area RA-1 and the out-of-service area RB is indicated by LB. The service area RA is a region in which the marine vessel 6 and the server 2 are communicable with each other via the network N or the like, and the marine vessel 6 located in the service area RA can download various types of information from the server 2. The out-of-service area RB is a region in which the marine vessel 6 and the server 2 are not communicable with each other, and thus the marine vessel 6 located in the out-of-service area RB cannot download various types of information from the server 2. The map information 18 includes information indicating that the service area RA is a region in which the marine vessel 6 is communicable and that the out-of-service area RB is a region in which the marine vessel 6 is not communicable.

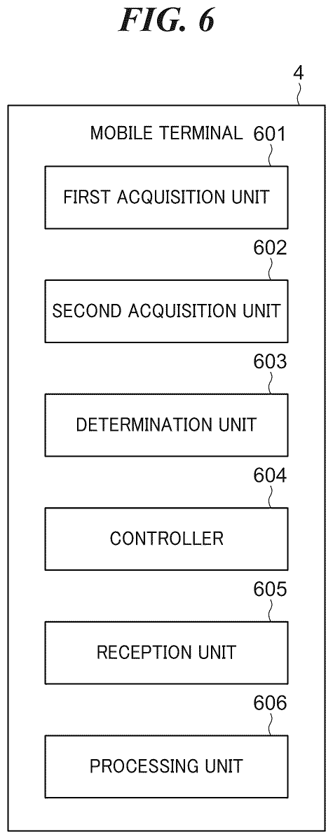

FIG. 6 is a diagram illustrating a functional block that implements a location information acquisition process (FIG. 7) in the mobile terminal 4. The functional block includes, as functional units, a first acquisition unit 601, a second acquisition unit 602, a determination unit 603, a controller 604, a reception unit 605, and a processing unit 606. These functional units are mainly implemented by cooperation of any two or more of the CPU 21, the ROM 22, the RAM 23, the memory 24, the display unit 25, the communication I/F 27, and the position detection unit 20 of the mobile terminal 4. In the mobile terminal 4, the application 28 is installed in advance. When the application 28 is activated, the functions of the functional units of the first acquisition unit 601, the second acquisition unit 602, the determination unit 603, and the controller 604 are executed. Note that the reception unit 605 and the processing unit 606 are functional units required in a second preferred embodiment of the present invention (described below), and are not essential in the present preferred embodiment.

FIG. 6 will be described with reference to FIGS. 4 and 5.

The first acquisition unit 601 acquires the position of the marine vessel 6 and at least one of the speed or the traveling direction of the marine vessel 6. Second acquisition unit 602 acquires communication area information indicating whether a certain region on map information 18 is service area RA or out-of-service area RB. The determination unit 603 determines whether the marine vessel 6 has been close to the out-of-service area RB based on the acquired position of the marine vessel 6 and at least one of the acquired speed or the acquired traveling direction of the marine vessel 6. In accordance with the determination that the marine vessel 6 has been close to the out-of-service area RB, the controller 604 downloads, from the server 2, location information on the region corresponding to the position of the marine vessel 6. As a result, it is possible, even when the marine vessel 6 enters the out-of-service area RB, to issue a warning by using the location information downloaded immediately before entering the out-of-service area RB. These processes can be executed when the marine vessel 6 is located in the service area RA, and is specifically implemented by the following modes.

The first acquisition unit 601 acquires the speed of the marine vessel 6 detected by the velocity sensor in the various sensors 45 and the position information output from the position detection unit 46 by receiving the speed and the position information from the microcomputer 5 of the marine vessel 6. Furthermore, the first acquisition unit 601 determines (calculates) the traveling direction from the temporal transition (that is, a change within a predetermined time) of the received position information. Alternatively, the first acquisition unit 601 may acquire the traveling direction by receiving the traveling direction determined (calculated) by the microcomputer 5.

The second acquisition unit 602 may acquire communication area information of a region within a certain radius from the current position by receiving the communication area information from the server 2 through the network N. The “constant radius” mentioned here is a distance that includes a region in which a warning is to be issued (a region to be a warning target), and is sufficiently longer than the distance L1 shown in FIG. 4. Note that the region in which the communication area information is to be acquired may be limited to a predetermined angular range in the traveling direction. For example, in the example of FIG. 4, information indicating that the service area RA-1 and the service area RA-2 are communicable regions, and that the out-of-service area RB is a non-communicable region is acquired, as the communication area information.

Several methods can be considered to determine, by the determination unit 603, whether the marine vessel 6 has been close to the out-of-service area RB. As an example, the determination unit 603 may determine that the marine vessel 6 has been close to the out-of-service area RB in a case where the distance L0 between the boundary LB between the service area RA-1 and the out-of-service area RB and the current position of the marine vessel 6 (indicated by a dotted line in FIG. 4) is less than a predetermined value. In this case, it is not necessary to use the speed. Alternatively, the determination unit 603 may calculate the time required for the marine vessel 6 to reach the boundary LB based on the position, speed, and traveling direction of the marine vessel 6, and determine that the marine vessel 6 has been close to the out-of-service area RB in a case where the time required for the marine vessel 6 to reach the boundary LB is shorter than a predetermined time. Alternatively, in a case where the boundary LB is included in a range of a predetermined radius from the current position, the determination unit 603 may determine that the marine vessel 6 has been close to the out-of-service area RB. In this case, it is not necessary to use the information on the traveling direction. Note that the determination unit 603 may determine that the marine vessel 6 has been close to the out-of-service area RB in a case where any one of these cases is applicable.

In response to the determination that the marine vessel 6 has been close to the out-of-service area RB, the controller 604 downloads the location information 19 from the server 2 via the network N. The timing to start downloading the location information 19 (hereinafter also referred to as “download start timing” or simply “start timing”) and the target region are described as follows.

First, the controller 604 may start downloading the location information 19 immediately when it is determined that the marine vessel 6 has been close to the out-of-service area RB (that is, at the timing when it is determined that the marine vessel 6 has been close to the out-of-service area RB). Alternatively, the controller 604 may determine a start timing to download the location information 19, and may start downloading the location information 19 at the time when the determined start timing arrives.

For example, the controller 604 may determine, as the download start timing of the location information 19, a timing after a lapse of a predetermined time from a time point at which it is determined that the marine vessel 6 has been close to the out-of-service area RB. Alternatively, the controller 604 may acquire the communication speed with the server 2 and the data volume of the location information 19 to be downloaded, and may determine the download start timing of the location information 19 based on the acquired communication speed and data volume. In this case, the download start timing of the location information 19 is determined to arrive earlier as the communication speed with the server 2 is slower or as the data volume of the location information 19 is larger. At that time, a distance L0 (FIG. 4) between the current position and the out-of-service area RB may also be considered. In a case where the download start timing of the location information 19 is determined based on the distance L0 to the out-of-service area RB, the communication speed with the server 2, and the data volume of the location information 19, the download start timing of the location information 19 is determined to arrive earlier, as the distance L0 is longer, as the communication speed with the server 2 is slower, or as the data volume of the location information 19 is larger.

The target region 401 is a region in which location information 19 is to be downloaded. The target region 401 may be a fixed range with the current position used as a standard. In this case, the controller 604 may determine the target region 401 so that the target region 401 includes a region within the first predetermined distance L1 in the traveling direction. It is assumed that the time point at which the marine vessel 6 arrives at the position indicated by the solid line in FIG. 4 is the download start timing of the location information 19. The first predetermined distance L1 is a fixed value, and is, for example, a straight distance (for example, 150 km) which the marine vessel 6 can navigate when the marine vessel 6 is full of fuel. The target region 401 is a fan-shaped region having an angular range of an angle θ centered on the traveling direction in the range of the first predetermined distance L1 from the estimated position of the marine vessel 6 at the download start timing of the location information 19.

Alternatively, the target region 401 may be variable, and the controller 604 may determine the target region 401 in which the location information 19 is to be downloaded based on the position, speed, and traveling direction of the marine vessel 6. In this case, the first predetermined distance L1 is longer as the speed of the marine vessel 6 increases. Note that the angle θ may also be variable based on the position, speed, and traveling direction of the marine vessel 6. For example, the angle θ may be set to be narrower as the speed of the marine vessel 6 increases.

Alternatively, in a case where the target region 401 is variable, the controller 604 may acquire information on the remaining amount of fuel used to propel the marine vessel 6 (in the present preferred embodiment, fuel such as gasoline for the engine 11) and consider the remaining amount. The controller 604 may determine the target region 401 based on the remaining amount of fuel, and the position, speed, and traveling direction of the marine vessel 6. In this case, the first predetermined distance L1 is longer as the remaining amount of fuel increases or as the speed of the marine vessel 6 increases.

In order to further simplify the process, the target region 401 may be a range of a predetermined radius with the current position used as a standard. In this case, it is not necessary to use the speed or the traveling direction of the marine vessel 6.

As illustrated in FIG. 5, the server 2 manages tiles by associating each tile with the presence or absence of call attention information and the presence or absence of structure information. In the present preferred embodiment, the server 2 treats a tile including the outline of the target region 401 as an area belonging to the target region 401. However, a tile including the outline of the target region 401 may be treated as an area not belonging to the target region 401.

The controller 604 acquires the location information 19 corresponding to the target region 401. The call attention information and the detailed map 18a in the location information 19 include at least those corresponding to the target region 401. The detailed map 18a further includes information indicating the structure 403 as the structure information.

When downloading the location information 19, the controller 604 may prioritize the download for a plurality of pieces of information included in the location information 19. For example, the controller 604 may preferentially download the call attention information. Alternatively, the controller 604 may preferentially download the location information 19 corresponding to the priority region 402. The priority region 402 in FIG. 5 indicates a region in the target region 401 having a high priority for downloading the location information 19.

Here, the priority region 402 is a fan-shaped region having an angular range of an angle θ with the traveling direction as the center in the range of the second predetermined distance L2 from the estimated position of the marine vessel 6 at the download start timing of the location information 19, and is narrower than the target region 401. The second predetermined distance L2 is, for example, 2 nautical miles.

Alternatively, when downloading the location information 19, the controller 604 may download the call attention information, the detailed map in the priority region 402, the structure information, and the detailed map outside the second predetermined distance L2 (that is, the detailed map in the region other than the priority region 402 in the target region 401), in this order.

FIG. 7 is a flowchart illustrating a location information acquisition process. In the mobile terminal 4, the location information acquisition process is implemented by the CPU 21 developing a program stored in the ROM 22 or the memory 24 in the RAM 23 and executing the program. The location information acquisition process is started when the application 28 is activated.

In step S101, the CPU 21 determines whether the map information 18, which is a chart, has already been acquired. In a case where the map information 18 has not been acquired (NO in step S101), the CPU 21 requests the server 2 for the map information 18, and downloads and acquires the map information 18 in step S110, and returns to step S101. In a case where the map information 18 has already been acquired (YES in step S101), the CPU 21 advances the process to step S102 and executes other processing. In other processing in step S102, when receiving an instruction to stop (interrupt) or end the application 28, the CPU 21 executes a process of stopping (interrupting) or ending the location information acquisition process illustrated in FIG. 7.

In step S103, as described above, the CPU 21 acquires the position (current position), the speed, and the traveling direction of the marine vessel 6 by receiving them from the microcomputer 5 or the like. Note that it is not essential to acquire the speed or the traveling direction of the marine vessel 6 in a case where the speed or the traveling direction is not used for subsequent processing.

In step S104, the CPU 21 acquires the communication area information by receiving the communication area information from the server 2 through the network N, as described above. In step S105, the CPU 21 determines whether the marine vessel 6 has been close to the out-of-service area RB by any of the methods described above. In a case where the CPU 21 determines that the marine vessel 6 has not been close to the out-of-service area RB, the CPU 21 returns the process to step S102. In a case where the CPU 21 determines that the marine vessel 6 has been close to the out-of-service area RB, the CPU 21 advances the process to step S106.

In step S106, the CPU 21 determines the “download start timing of the location information 19” and the “target region 401” by any of the methods described above. In step S107, the CPU 21 determines whether or not the determined start timing has arrived. If the time point, at which it is determined that the marine vessel 6 has been close to the out-of-service area RB, is determined as the start timing, it is determined in step S107 that the start timing has arrived immediately.

In a case where it is determined in step S107 that the start timing has not arrived, the CPU 21 advances the process to step S111 and determines whether or not there is a change in the traveling direction of the marine vessel 6. Note that, in a case where the process of step S111 is applied, it is assumed that the information on the traveling direction of the marine vessel 6 is sequentially acquired. In a case where there is no change in the traveling direction of the marine vessel 6 (NO in step S111), the CPU 21 returns the process to step S107; whereas in a case where there is a change in the traveling direction of the marine vessel 6 (YES in step S111), the CPU 21 returns the process to step S102.

Note that, in step S111, also in a case where the speed of the marine vessel 6 has changed, the CPU 21 may return the process to step S102. It is not essential to provide step S111, and the CPU 21 may wait, in step S107, until the download start timing of the location information 19 arrives.

In a case where it is determined in step S107 that the start timing has arrived, the CPU 21 advances the process to step S108 and starts downloading the location information 19 corresponding to the determined target region 401. At this time, as described above, in a case where download priorities are provided to a plurality of pieces of information included in the location information 19, the information is downloaded according to the priorities. Whether or not to prioritize downloading may be designated by an instruction from the user of the mobile terminal 4 in other processing in step S102.

In order to start downloading the location information 19, the CPU 21 issues a transmission request for the location information 19 to the server 2. In response to the transmission request, the server 2 transmits the corresponding location information 19 to the mobile terminal 4. When the transmission of the requested location information 19 is completed, the server 2 transmits a completion notification of that effect to the mobile terminal 4.

In step S109, the CPU 21 executes other processing, and ends the location information acquisition process illustrated in FIG. 7. In other processing in step S109, the CPU 21 may start the timer so as to restart the location information acquisition process illustrated in FIG. 7 after waiting for a certain time after ending the location information acquisition process illustrated in FIG. 7. In addition, in other processing in step S109, when a completion notification indicating that the transmission of the location information 19 has been completed is received from the server 2, the CPU 21 may notify of the completion by screen display or voice.

According to the present preferred embodiment, in the mobile terminal 4, the position of the marine vessel 6, and at least one of the speed or the traveling direction of the marine vessel 6 are acquired, and the communication area information is acquired. It is determined whether or not the marine vessel 6 has been close to the out-of-service area RB based on the acquired position of the marine vessel 6 and the acquired at least one of the acquired speed or traveling direction of the marine vessel 6. In response to the determination that the marine vessel 6 has been close to the out-of-service area RB, the location information 19 regarding the target region 401 according to the position of the marine vessel 6 is downloaded from the server 2. As a result, even if the marine vessel 6 newly enters the out-of-service area RB, the location information 19 corresponding to the target region 401 has been downloaded immediately before the marine vessel 6 newly enters the out-of-service area RB. Therefore, it is possible to prevent a situation in which a warning cannot be issued after the marine vessel 6 enters the out-of-service area RB.

In addition, in a case where the download of the location information 19 is started at the timing when it is determined that the marine vessel 6 has been close to the out-of-service area RB, the location information 19 can be acquired immediately, and a situation in which a warning cannot be issued is prevented more reliably.

In addition, the CPU 21 determines a start timing of downloading the location information 19 in a case where it is determined that the marine vessel 6 has been close to the out-of-service area RB, and starts downloading the location information 19 at the time when the determined start timing arrives. As a result, the download is started when the necessity of the location information 19 increases, which makes it possible to prevent useless data acquisition.

In addition, in a case where the download start timing of the location information 19 is determined based on the communication speed with the server 2 and the data volume of the location information 19 to be downloaded, the download can be started in time for the acquisition of necessary data, and useless data acquisition is prevented.

Further, in a case where a region including a region within the first predetermined distance L1 in the traveling direction of the marine vessel 6 is determined as the target region 401, the process can be simplified. Alternatively, in a case where the target region 401 is determined based on the position of the marine vessel 6 and at least one of the speed or the traveling direction of the marine vessel 6, the target region 401 can be determined in a more appropriate range as necessary. In a case where the target region 401 is determined based on the remaining amount of fuel used to propel the marine vessel 6, the position of the marine vessel 6, and at least one of the speed or the traveling direction of the marine vessel 6, the target region 401 can be determined within a navigable range according to the remaining amount of fuel.

In addition, by preferentially downloading the call attention information when the location information 19 is downloaded, information necessary to issue a warning can be preferentially acquired. In addition, in a case where when the location information 19 is downloaded, the call attention information, the detailed map 18a within the second predetermined distance L2, the structure information, and the detailed map 18a outside the second predetermined distance L2 are downloaded in this order, information with a high degree of necessity can be preferentially acquired.

Note that, in the present preferred embodiment, the location information acquisition process illustrated in FIG. 7 is executed by the mobile terminal 4 serving as the information processing apparatus. However, the present invention is not limited thereto. For example, the microcomputer 5 may execute a location information acquisition process and download the location information 19 from the server 2. In this case, the microcomputer 5 serves as an information processing apparatus.

In a case where it is determined that the marine vessel 6 has been close to the out-of-service area RB and it is estimated that the marine vessel 6 enters the next service area RA immediately after entering the out-of-service area RB, the target region 401 may be reduced. For example, in a case where the next service area RA is included in the target region 401 temporarily determined in a manner as described above, a region acquired by excluding the next service area RA from the temporarily determined target region 401 may be determined as the proper target region 401. As a result, the data volume of the location information 19 to be downloaded can be reduced.

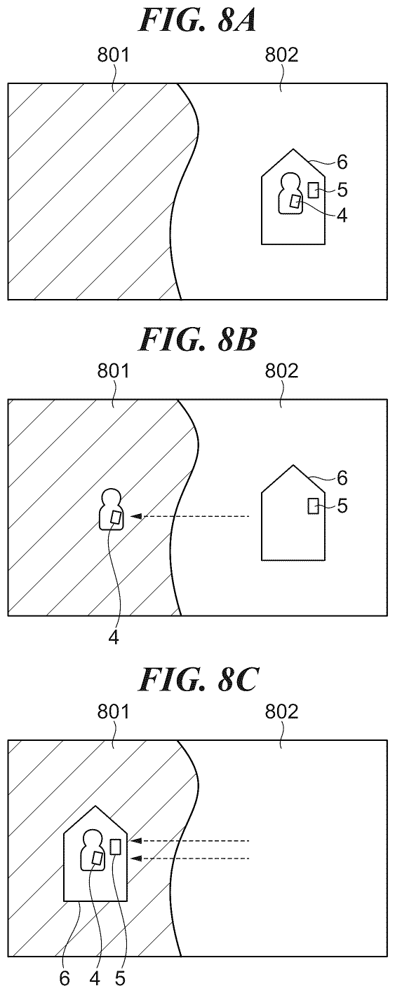

A second preferred embodiment of the present invention will be described with reference to FIGS. 8A to 12B.

Conventionally, in some cases, in order to record track information, a communication terminal apparatus such as a smartphone possessed by a vessel operator acquires position information thereof from a GPS or the like and uploads the acquired position information to a server during navigation.

In the field of vehicles, a technology for protecting personal information by not transmitting position information when a vehicle is within a predetermined region, is disclosed (for example, in Japanese Patent No. 4984334). Protection of personal information also needs to be considered in the field of marine vessels. From the viewpoint of personal information protection, it may not be appropriate to record track information depending on the situation. Therefore, in the present preferred embodiment, unnecessary provision of the position information is prevented by the process described below.

FIGS. 8A to 8C are conceptual diagrams illustrating a positional relationship between the marine vessel 6 and the mobile terminal 4. In each of FIGS. 8A to 8C, a land area 801 and a sea area 802 are shown. The mobile terminal 4 is exemplified as a communication apparatus carried by the vessel operator, and the microcomputer 5 is exemplified as a communication apparatus provided in the marine vessel 6. Here, main processing modes will be outlined, and details will be described below (FIG. 9). Note that a location information acquisition process (FIG. 7) of the second preferred embodiment is similar to that of the first preferred embodiment.

The CPU 21 of the mobile terminal 4 executes the position information providing process (FIG. 9) by activating the application 29 installed in advance. In the position information providing process, as a basic operation, the CPU 21 acquires the position information of the mobile terminal 4 and uploads the acquired position information to the server 2 through the network N. The position information of the mobile terminal 4 to the server 2 such that the manager of the marina or the vessel operator can check track information of their own marine vessel 6.

In FIG. 8A, both the marine vessel 6 and the mobile terminal 4 are located in the sea area 802. In this situation, the CPU 21 uploads the position information of the mobile terminal 4 to the server 2 in principle. In FIG. 8B, the mobile terminal 4 lands and is located in the land area 801, whereas the marine vessel 6 is located in the sea area 802. In this situation, the process of acquiring the position information of the mobile terminal 4 is ended or interrupted, and therefore the position information of the mobile terminal 4 is not uploaded to the server 2. When the user carrying the mobile terminal 4 lands, the position information is not uploaded, so that unnecessary provision of the position information is prevented, leading to protection of personal information.

In FIG. 8C, the marine vessel 6 and the mobile terminal 4 both land and are located on the land area 801. In this situation, the process of acquiring the position information of the mobile terminal 4 ends, and therefore the position information of the mobile terminal 4 is not uploaded to the server 2.

The controller 604, the reception unit 605, and the processing unit 606 (see FIG. 6) correspond to the functional units that implement the position information providing process (FIG. 9). In the mobile terminal 4, the application 29 is installed in advance. When the application 29 is activated, the functions of the functional units of the controller 604, the reception unit 605, and the processing unit 606 are executed. Note that the first acquisition unit 601, the second acquisition unit 602, and the determination unit 603 are not essential from the viewpoint of implementing the position information providing process (FIG. 9).

The reception unit 605 is configured to receive an instruction (a start instruction) to start and an instruction (an end instruction) to end the process of acquiring position information of the communication apparatus (mobile terminal 4) (hereinafter, referred to as “position information acquisition process”). For example, the user of the mobile terminal 4 can input a start instruction or an end instruction by operating the input unit 26. The CPU 21 receives the start instruction or the end instruction by detecting the input operation.

The processing unit 606 starts the position information acquisition process of the communication apparatus (mobile terminal 4) in response to the reception of the start instruction, and ends the position information acquisition process in response to the reception of the end instruction.

The controller 604 determines whether the communication apparatus (mobile terminal 4) is located in the sea area 802 or the land area 801 based on the acquired position information, and uploads the position information to the server 2 on a condition that it is determined that the communication apparatus is located in the sea area 802.

Operation modes in which the reception unit 605 can receive an instruction (input), include an immediate end mode (first mode) and an interruption mode (second mode), which are selectively received and set.

FIG. 9 is a flowchart illustrating a position information providing process. In the mobile terminal 4, the position information providing process is implemented by the CPU 21 developing a program stored in the ROM 22 or the memory 24 in the RAM 23 and executing the program. This process is started when the application 29 is activated.

In step S201, the CPU 21 waits until an instruction to start the position information acquisition process is received, and when the instruction to start the position information acquisition process is received, the CPU 21 executes other processing in step S202. In other processing of step S202, for example, when receiving an instruction to end the application 29, the CPU 21 executes a process to end the position information providing process illustrated in FIG. 9. Note that the CPU 21 may be end the position information providing process also when an instruction to end the application 29 is received during waiting for the start instruction (S201).

In step S203, the CPU 21 starts the position information acquisition process. That is, the CPU 21 acquires the current position of the mobile terminal 4 based on the output of the position detection unit 20. Thereafter, the acquisition of the current position of the mobile terminal 4 is continued until the position information providing process is ended.

In step S204, the CPU 21 refers to the current position of the mobile terminal 4 and determines whether or not the mobile terminal 4 belongs to (is located in) the sea area 802. In a case where the mobile terminal 4 belongs to the sea area 802 (FIG. 8A) (YES in step S204), the CPU 21 advances the process to step S205 and uploads the position information of the mobile terminal 4 to the server 2, wherein the position information of the mobile terminal 4 to be uploaded is the latest information acquired.

Next, in step S206, the CPU 21 determines whether or not an instruction to end the position information acquisition process has been received. In a case where the instruction to end the position information acquisition process is not received (NO in step S206), the CPU 21 returns the process to step S202. That is, in a case where the mobile terminal 4 continues to be located in the sea area 802, the process of steps S202 to S206 is repeatedly executed, that is, the upload of the position information of the mobile terminal 4 to the server 2 is continued.

In a case where the instruction to end the position information acquisition process is received (YES in step S206), the CPU 21 advances the process to step S207, ends the position information acquisition process, and returns the process to step S201. That is, the acquisition of the current position of the mobile terminal 4 based on the output of the position detection unit 20 is ended, and thereafter, the position information acquisition process is not resumed until an instruction to start the position information acquisition process is received again.

In a case where the mobile terminal 4 does not belong to the sea area 802 (that is, the mobile terminal 4 belongs to the land area 801 (FIG. 8B, 8C)) (NO in step S204), the CPU 21 advances the process to step S208. In step S208, the CPU 21 determines whether or not the immediate end mode is set. In a case where the immediate end mode is set (YES in step S208), the CPU 21 executes the process of step S207. That is, in a case where the immediate end mode is set, in a case where at least the mobile terminal 4 of the mobile terminal 4 or the marine vessel 6 is landed, the position information acquisition process is immediately ended without requiring (receiving) the instruction to end the position information acquisition process, and the position information acquisition process is not resumed until the instruction to start the position information acquisition process is received again.

In a case where the immediate end mode is not set (NO in step S208), the suspension mode is set, and the CPU 21 therefore advances the process to step S209. In step S209, the CPU 21 interrupts the position information acquisition process and advances the process to step S210. The interruption of the position information acquisition process in step S209 causes current position of the mobile terminal 4 to be not acquired.

In step S210, the CPU 21 determines whether or not both the mobile terminal 4 and the marine vessel 6 belong to (are located in) the land area 801. In a case where both the mobile terminal 4 and the marine vessel 6 belong to the land area 801 (YES in step S210), the CPU 21 executes the process of step S207. That is, even during the suspension of the position information acquisition process, when both the mobile terminal 4 and the marine vessel 6 land (FIG. 8C), the position information acquisition process is automatically ended without requiring (receiving) an instruction to end the position information acquisition process.

In a case where at least one of the mobile terminal 4 or the marine vessel 6 does not belong to the land area 801 (substantially, in a case where the mobile terminal 4 belongs to the land area 801 and the marine vessel 6 belongs to the sea area 802 (FIG. 8B)) (NO in step S210), the CPU 21 advances the process to step S211. In step S211, the CPU 21 determines whether or not the mobile terminal 4 belongs to the sea area 802 (that is, whether or not the mobile terminal 4 has moved from the land area 801 to the sea area 802). In a case where the mobile terminal 4 does not belong to the sea area 802 (NO in step S211), that is, the situation shown in FIG. 8B is still continuing, and the CPU 21 returns the process to step S210.

Then, when the mobile terminal 4 comes to belong in the sea area 802 (YES in step S211), the CPU 21 advances the process from step S211 to step S202. Therefore, for example, when the mobile terminal 4 returns to the sea area 802 while the position information acquisition process is interrupted, the position information acquisition process is automatically resumed without requiring re-reception of the instruction to start the position information acquisition process.

According to the second preferred embodiment, it is possible to achieve an effect similar to that of the first preferred embodiment with respect to preventing a situation in which a warning cannot be issued when the marine vessel 6 enters the out-of-service area RB by executing the location information acquisition process (FIG. 7).

Furthermore, according to the second preferred embodiment, in the position information providing process (FIG. 9), the CPU 21 starts the position information acquisition process in response to reception of an instruction to start the position information acquisition process, and ends the position information acquisition process in response to reception of an instruction to end the position information acquisition process. The CPU 21 uploads the position information of the mobile terminal 4 to the server 2 on a condition that the mobile terminal 4 is determined to be located in the sea area 802 based on the position information. Therefore, even after the start of the position information providing process, the position information is not uploaded when the mobile terminal 4 is on land so that unnecessary provision of the position information of the mobile terminal 4 is prevented. In addition, the server 2 does not store unnecessary information, and thus a storage capacity to be secured in the server 2 is prevented.

In particular, in the case of the immediate end mode, when the mobile terminal 4 lands, the position information providing process is immediately and automatically ended (S208 S207). Therefore, it is not necessary to give an end instruction, which is convenient for the user.

In the suspension mode, when the mobile terminal 4 is located in the land area 801, the position information providing process is temporarily interrupted (S209), and when the mobile terminal 4 returns to the sea area 802 again, the position information providing process is automatically resumed (S210→S211→S202). Therefore, the end instruction is not required to interrupt the process and the start instruction is not required to restart the process, which is convenient for the user.

In addition, when it is determined that both the mobile terminal 4 and the marine vessel 6 are located in the land area 801, the position information providing process is automatically ended even during the interruption of the position information providing process (S210→S207). Therefore, it is not necessary to give an end instruction, which is convenient for the user.

In addition, the immediate end mode or the suspension mode can be selectively set as the operation mode, which makes it possible to designate whether or not a start instruction is required to restart the process (S207 to S209), which is convenient for the user.

Note that it is not essential to provide the immediate end mode. In a case where the immediate end mode is not provided, step S208 may be eliminated, and in a case where NO is determined in step S204, the process may proceed to step S209. In addition, from the viewpoint of further simplifying the process, it is not essential to provide the interruption mode. In a case where neither the immediate end mode nor the interruption mode is provided, steps S208 to S211 may be eliminated, and the process may proceed to step S207 in a case where NO is determined in step S204.

In the present preferred embodiment, it is not essential to execute the location information acquisition process (FIG. 7) described in the first preferred embodiment. In a case where the location information acquisition process is not executed, it is not necessary to install the application 28. In this case, the first acquisition unit 601, the second acquisition unit 602, and the determination unit 603 may be eliminated. Furthermore, in this case, the controller 604 does not need to have a function to execute the location information acquisition process.

Next, modifications of the second preferred embodiment will be described. In each modification described below, the position information providing process is different from that illustrated in FIG. 9.

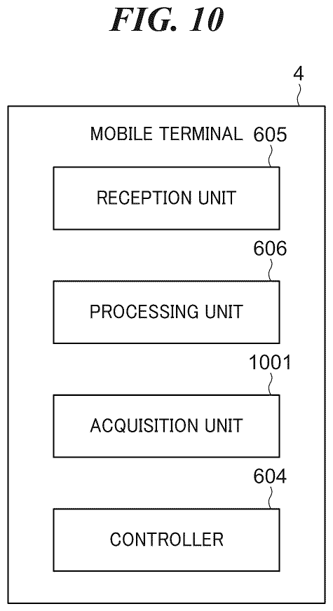

FIG. 10 is a diagram illustrating a functional block that implements the position information providing process in the mobile terminal 4. The functional block includes a reception unit 605, a processing unit 606, an acquisition unit 1001, and a controller 604, as functional units. These functional units are mainly implemented by cooperation of any two or more of the CPU 21, the ROM 22, the RAM 23, the memory 24, the display unit 25, the communication I/F 27, and the position detection unit 20 of the mobile terminal 4. When the application 29 is activated, the functions of these functional units are executed.

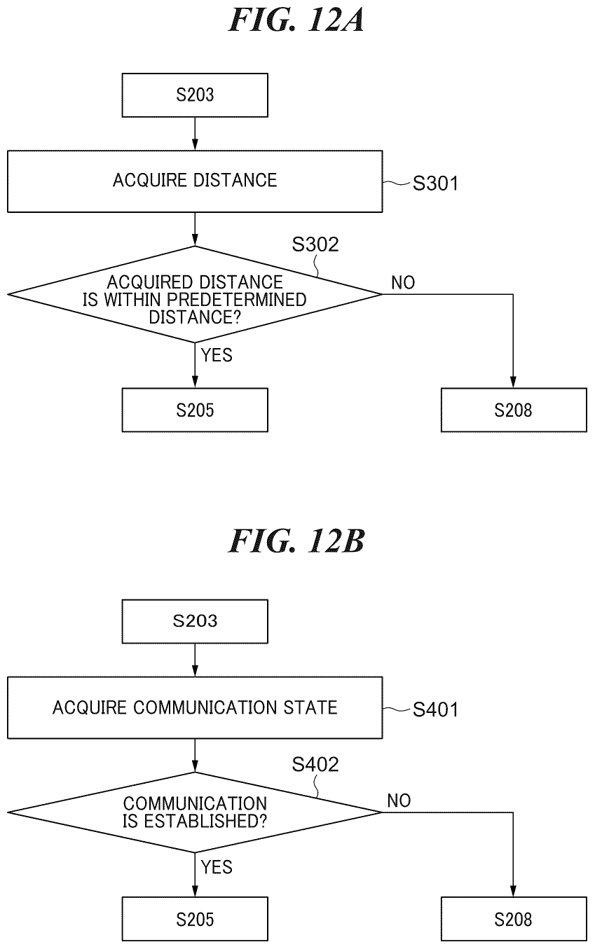

As modifications of the position information providing process, a first modification (FIG. 12A) and a second modification (FIG. 12B) will be described. In both the first modification and the second modification, the function of the reception unit 605 and the function of the processing unit 606 are the same as those described as the second preferred embodiment.

In the first modification, the acquisition unit 1001 (third acquisition step) acquires the distance between the mobile terminal 4 (communication apparatus) and the marine vessel 6. The controller 604 uploads the position information of the mobile terminal 4 to the server 2 on a condition that the acquired distance is within a third predetermined distance.

In the second modification, the acquisition unit 1001 (fourth acquisition step) acquires the communication state between the mobile terminal 4 (communication apparatus) and the marine vessel 6. The controller 604 uploads the position information of the mobile terminal 4 to the server 2 on a condition that communication between the communication apparatus and the marine vessel 6 is established.

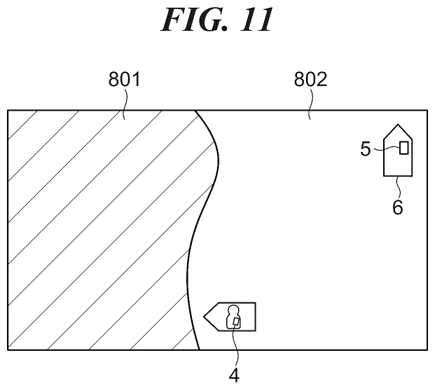

FIG. 11 is a conceptual diagram illustrating a positional relationship between the marine vessel 6 and the mobile terminal 4.

In FIG. 11, the distance between the mobile terminal 4 and the marine vessel 6 exceeds a third predetermined distance, which case corresponds to, for example, a case where a user carrying the mobile terminal 4 moves from the marine vessel 6 to another marine vessel. In FIG. 11, communication between the mobile terminal 4 and the marine vessel 6 is disconnected. Similar situations may include a case where only the mobile terminal 4 has landed as illustrated in FIG. 8B.

FIG. 12A is a portion of a flowchart illustrating position information providing process according to the first modification. The process in steps S201 to S203 and S205 to S211 in the first modification is similar to the corresponding process in FIG. 9. The position information providing process in the first modification is different from the position information providing process illustrated in FIG. 9 in that steps S301 and S302 are provided instead of step S204 in FIG. 9.

After step S203, the CPU 21 acquires the distance between the mobile terminal 4 and the marine vessel 6 in step S301. This distance is determined from the position information of both the mobile terminal 4 and the marine vessel 6. In step S302, the CPU 21 determines whether or not the acquired distance is within a third predetermined distance. The third predetermined distance is set in advance to, for example, a value equal to or greater than the distance between the mobile terminal 4 and the marine vessel 6 when assuming the case that “the user carrying the mobile terminal 4 disembarked from the marine vessel 6 and clearly/obviously away from the marine vessel 6”.

In a case where the acquired distance is within the third predetermined distance, the CPU 21 advances the process to step S205, and thus, the position information of the mobile terminal 4 is uploaded to the server 2. On the other hand, in a case where the acquired distance is not within the third predetermined distance, the CPU 21 advances the process to step S208.

Therefore, in the first modification, the position information of the mobile terminal 4 is uploaded to the server 2 on a condition that the acquired distance is within the third predetermined distance. On the other hand, when the mobile terminal 4 moves away from the marine vessel 6 by a distance beyond the third predetermined distance, the position information providing process is interrupted or ended. Therefore, unnecessary provision of the position information is prevented.

FIG. 12B is a portion of a flowchart illustrating position information providing process according to the second modification. The process in steps S201 to S203 and S205 to S211 in the second modification is similar to the corresponding process in FIG. 9. The position information providing process in the second modification is different from the position information providing process illustrated in FIG. 9 in that steps S401 and S402 are provided instead of step S204 in FIG. 9.

After step S203, the CPU 21 acquires the communication state between the mobile terminal 4 and the marine vessel 6 in step S401. Here, it is assumed that the mobile terminal 4 and the marine vessel 6 are able to communicate with each other by near field wireless communication, for example. In step S402, the CPU 21 determines whether or not communication between the mobile terminal 4 and the marine vessel 6 is established. Then, in a case where the communication between the mobile terminal 4 and the marine vessel 6 is established, the CPU 21 advances the process to step S205, and thus, the position information of the mobile terminal 4 is uploaded to the server 2. On the other hand, in a case where the communication between the mobile terminal 4 and the marine vessel 6 is not established, the CPU 21 advances the process to step S208.

Therefore, in the second modification, the position information of the mobile terminal 4 is uploaded to the server 2 on a condition that the communication between the mobile terminal 4 and the marine vessel 6 is established. On the other hand, when the communication between the mobile terminal 4 and the marine vessel 6 is not established or disconnected, the position information providing process is interrupted or ended. For example, in a state where the mobile terminal 4 is away from the marine vessel 6 to such an extent that communication is impossible, the position information of the mobile terminal 4 is not uploaded. Therefore, unnecessary provision of the position information is prevented.

Note that, in the second preferred embodiment or the modifications thereof, the position information providing process (FIG. 9, FIG. 12A, and FIG. 12B) is executed by the mobile terminal 4 serving as the information process apparatus. However, the present invention is not limited thereto. For example, the microcomputer 5 may execute the position information providing process and upload the position information of the mobile terminal 4 to the server 2. In this case, the microcomputer 5 serves as an information processing apparatus.

Note that, in the second preferred embodiment or the modifications thereof, in a case where it is not necessary to execute the location information acquisition process (FIG. 7), the following method, or an apparatus and a non-transitory computer readable medium including a program that implements the method are encompassed by the scope of the present invention.

According to a preferred embodiment of the present invention, an information processing method causes a computer of a communication apparatus able to communicate with a server to execute receiving a start instruction or an end instruction; starting a position information acquisition process to acquire position information of the communication apparatus in response to reception of the start instruction, and ending the position information acquisition process in response to reception of the end instruction; and determining whether the communication apparatus is located in a sea area or a land area based on the acquired position information of the communication apparatus, and uploading the position information of the communication apparatus to the server on a condition that it is determined that the communication apparatus is located in the sea area.

According to a preferred embodiment of the present invention, an information processing method causes a computer of a communication apparatus able to communicate with a server to execute receiving a start instruction or an end instruction; starting a position information acquisition process to acquire position information of the communication apparatus in response to reception of the start instruction, and ending the position information acquisition process in response to reception of the end instruction; acquiring a distance between the communication apparatus and a marine vessel; and uploading position information of the communication apparatus to the server on a condition that the acquired distance is within a third predetermined distance.

According to a preferred embodiment of the present invention, an information processing method causes a computer of a communication apparatus able to communicate with a server to execute receiving a start instruction or an end instruction; starting a position information acquisition process to acquire position information of the communication apparatus in response to reception of the start instruction, and ending the position information acquisition process in response to reception of the end instruction; acquiring a communication state between the communication apparatus and a marine vessel; and uploading position information of the communication apparatus to the server on a condition that communication between the communication apparatus and the marine vessel is established.

In each of the above preferred embodiments, the propulsion device of the marine vessel 6 is not limited to a propulsion device having a configuration including an engine as a drive source, and the propulsion device of the marine vessel 6 may have a configuration including, for example, an electric motor.

Preferred embodiments of the present invention can be implemented by a process in which a program to implement one or more functions, which are described in preferred embodiments above, is supplied to a system or an apparatus via a network or a non-transitory storage medium, and one or more processors of a computer of the system or the apparatus reads and executes the program. The above program and the storage medium storing the above program are encompassed by the scope of the present invention. The present invention can also be implemented by a circuit (for example, ASIC) that implements one or more of the functions.

In a case where a warning is issued during navigation based on location information, in a case where there are many call attention points and/or in a case where a mesh for dividing a region on a detailed map to define tiles is extremely fine (as a result, the mesh information increases), an interruption process and the like at each tile and the call attention point increase. Then, data processing occurs every time the screen of the mobile terminal 4 or the marine vessel 6 is scrolled to display a position other than the currently displayed range. Therefore, the movement of the screen at the time of screen scrolling is slowed down.

Therefore, the process of depicting the area range in the scroll direction beyond the currently displayed area range may be performed in the background. As a result, the motion of the screen at the time of scrolling becomes smooth.

In order to implement the above method, for example, methods (techniques) disclosed in Japanese Patent No. 2619058, Japanese Patent No. 3141731, Japanese Laid-open Patent Publication (Kokai) No. H7-311046, Japanese Laid-open Patent Publication (Kokai) No. H8-314373, and the like can be used.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An information processing method executed by a computer of a communication apparatus able to communicate with a server, the information processing method comprising:
acquiring a position of a marine vessel, and at least one of a speed of the marine vessel or a traveling direction of the marine vessel;
acquiring communication area information indicating whether a region on a chart is a service communication area or an out-of-service communication area;
determining whether or not the marine vessel has been close to the out-of-service communication area based on the position of the marine vessel and the at least one of the speed of the marine vessel or the traveling direction of the marine vessel; and
downloading, from the server, location information including call attention information used to issue a warning regarding a region corresponding to the position of the marine vessel in response to the determination that the marine vessel has been close to the out-of-service communication area.

2. The information processing method according to claim 1, further comprising:
starting downloading of the location information when it is determined that the marine vessel has been close to the out-of-service communication area.

3. The information processing method according to claim 1, further comprising:
in a case where it is determined that the marine vessel has been close to the out-of-service communication area, determining a start timing to download the location information, and starting downloading of the location information when the determined start timing arrives.

4. The information processing method according to claim 3, further comprising:
acquiring a communication speed with the server and a data volume of the location information to be downloaded, and determining the start timing based on the communication speed and the data volume.

5. The information processing method according to claim 1, wherein a target region in which the location information is to be downloaded includes a region within a first predetermined distance in the traveling direction.

6. The information processing method according to claim 1, further comprising:
determining a target region in which the location information is to be downloaded based on the position of the marine vessel and the at least one of the speed of the marine vessel or the traveling direction of the marine vessel.

7. The information processing method according to claim 1, further comprising:
acquiring a remaining amount of fuel used to propel the marine vessel, and determining a target region in which the location information is to be downloaded based on the remaining amount of fuel, a position of the marine vessel, and the at least one of the speed of the marine vessel or the traveling direction of the marine vessel.

8. The information processing method according to claim 1, wherein
the location information includes a plurality of pieces of information; and
the information processing method further includes preferentially downloading the call attention information when downloading the location information.

9. The information processing method according to claim 1, wherein
the location information includes map information that is more detailed than the chart, and structure information; and
the information processing method further includes:
when downloading the location information, downloading the call attention information, the detailed map information within a second predetermined distance, the structure information, and the detailed map information outside the second predetermined distance, in this order.

10. A marine vessel comprising:
a functional unit including at least one memory to store a set of instructions, and at least one processor configured or programmed to:
acquire a position of the marine vessel, and at least one of a speed of the marine vessel or a traveling direction of the marine vessel;
acquire communication area information indicating whether a region on a chart is a service communication area or an out-of-service communication area;
determine whether or not the marine vessel has been close to the out-of-service communication area based on the position of the marine vessel and the at least one of the speed of the marine vessel or the traveling direction of the marine vessel; and
download location information including call attention information used to issue a warning regarding a region corresponding to the position of the marine vessel in response to the determination that the marine vessel has been close to the out-of-service communication area.

11. An information processing apparatus comprising:
at least one memory to store a set of instructions; and
at least one processor configured or programmed to cause the information processing apparatus to:
acquire a position of a marine vessel, and at least one of a speed of the marine vessel or a traveling direction of the marine vessel;
acquire communication area information indicating whether a region on a chart is a service communication area or an out-of-service communication area;
determine whether or not the marine vessel has been close to the out-of-service communication area based on the position of the marine vessel and the at least one of the speed of the marine vessel or the traveling direction of the marine vessel; and
download location information including call attention information used to issue a warning regarding a region corresponding to the position of the marine vessel in response to the determination that the marine vessel has been close to the out-of-service communication area.

12. A non-transitory storage medium storing a program to cause a computer of a communication apparatus able to communicate with a server to execute an information processing method, the information processing method comprising:
acquiring a position of a marine vessel, and at least one of a speed of the marine vessel or a traveling direction of the marine vessel;
acquiring communication area information indicating whether a region on a chart is a service communication area or an out-of-service communication area;
determining whether or not the marine vessel has been close to the out-of-service communication area based on the position of the marine vessel and the at least one of the speed of the marine vessel or the traveling direction of the marine vessel; and
downloading, from the server, location information including call attention information used to issue a warning regarding a region corresponding to the position of the marine vessel in response to the determination that the marine vessel has been close to the out-of-service communication area.

13. The information processing method according to claim 1, further comprising:
receiving a start instruction or an end instruction; and
starting a position information acquisition process to acquire position information of the communication apparatus in response to reception of the start instruction, and ending the position information acquisition process in response to reception of the end instruction; wherein
it is determined whether the communication apparatus is located in a sea area or a land area based on the acquired position information of the communication apparatus; and
the position information of the communication apparatus is uploaded to the server on a condition that it is determined that the communication apparatus is located in the sea area.

14. The information processing method according to claim 13, further comprising:
ending the position information acquisition process in a case where it is determined that the communication apparatus is located in the land area after the position information acquisition process is started.

15. The information processing method according to claim 13, further comprising:
interrupting the position information acquisition process in a case where it is determined that the communication apparatus is located in the land area after the position information acquisition process is started, and afterwards resuming the position information acquisition process in a case where it is determined that the communication apparatus is located in the sea area.

16. The information processing method according to claim 15, further comprising:
in a case where it is determined that both the communication apparatus and the marine vessel are located in the land area, ending the position information acquisition process even during interruption of the position information acquisition process.

17. The information processing method according to claim 13, further comprising:
selectively receiving a first mode and a second mode; wherein
the first mode ends the position information acquisition process in a case where it is determined that the communication apparatus is located in the land area after the position information acquisition process is started; and
the second mode interrupts the position information acquisition process in a case where it is determined that the communication apparatus is located in the land area after the position information acquisition process is started, and afterwards resumes the position information acquisition process in a case where it is determined that the communication apparatus is located in the sea area.

18. The information processing method according to claim 1, further comprising:
receiving a start instruction or an end instruction;
starting a position information acquisition process to acquire position information of the communication apparatus in response to reception of the start instruction, and ending the position information acquisition process in response to reception of the end instruction; and
acquiring a distance between the communication apparatus and the marine vessel; wherein
the position information of the communication apparatus is uploaded to the server on a condition that the acquired distance is within a third predetermined distance.

19. The information processing method according to claim 1, further comprising:
receiving a start instruction or an end instruction;
starting a position information acquisition process to acquire position information of the communication apparatus in response to reception of the start instruction, and ending the position information acquisition process in response to reception of the end instruction; and
acquiring a communication state between the communication apparatus and a marine vessel; wherein
the position information of the communication apparatus is uploaded to the server on a condition that communication between the communication apparatus and the marine vessel is established.
